(19) United States
(12) Patent Application Publication
(10) Pub. No.: US 2026/0257683 A1
(43) Pub. Date: Sep. 3, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Ryota Kameda, Tokyo (JP); Sho Tamura, Tokyo (JP)

(21) Appl. No.: 19/550,392

(22) Filed: Feb. 26, 2026

(30) Foreign Application Priority Data
Feb. 28, 2025 (JP) 2025-031414

(51) Int. Cl. B60W 30/18; B60W 10/20; B60W 50/14; G01C 21/36

(52) U.S. Cl. CPC B60W 30/18159; B60W 10/20; B60W 50/14; G01C 21/367; B60W 2050/146; B60W 2520/06; B60W 2552/10; B60W 2552/53; B60W 2556/40; B60W 2710/20; B60W 2720/10

(57) ABSTRACT

A vehicle control device according to an embodiment includes a processor that executes instructions to: recognize left and right device dividing lines seen from a vehicle; recognize map dividing lines defining the driving lane of the vehicle from map information; perform a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction, and if the comparison results satisfy a specific condition, perform the left and the right side dividing line comparison at a second distance shorter than the first distance; and that performs control of the vehicle based on the comparison results.

### CROSS-REFERENCE TO RELATED APPLICATION

Priority is claimed on Japanese Patent Application No. 2025-31414, filed February 28, 2025, the content of which is incorporated herein by reference.

### BACKGROUND

### Field of the Invention

The present invention relates to a vehicle control device, a vehicle control method, and a storage medium.

### Description of Related Art

In recent times, efforts to provide access to sustainable transportation systems that take into consideration vulnerable people among traffic participants have become more active. To achieve this, the focus is on research and development to further improve traffic safety and convenience through research and development into automated driving technology. In this regard, in the related art, a technology is known in which, when it is determined that there is a discrepancy between road dividing lines shown in camera images and road dividing lines shown in map information, and when it is determined that a vehicle is at a branch point shown in the map information, a driving mode of the vehicle is decided on the basis of a branching direction of the branch point and directions of the road dividing lines shown in the camera images (for example, Japanese Unexamined Patent Application, First Publication No. 2024-150513).

### SUMMARY

Incidentally, in the automated driving technology in the related art, it cannot be said that sufficient study has been conducted into methods for comparing road dividing lines recognized by detection devices such as cameras with road dividing lines shown in map information, and there is still room for further study. For that reason, there is a problem that appropriate driving control may not be performed on the basis of the recognition results of the road dividing lines.

In order to solve the above problems, one of objects of the present application is to provide a vehicle control device, a vehicle control method, and a storage medium in which more appropriate driving control can be implemented on the basis of the recognition results of road dividing lines. In addition, this ultimately contributes to the development of sustainable transportation systems.

A vehicle control device, a vehicle control method, and a storage medium according to the present invention employ the following configurations.
(1): A vehicle control device according to one aspect of the present invention including: a memory storing a instructions; and a processor configured to execute the instructions stored in the memory to: recognize left and right dividing lines seen from a vehicle defining a driving lane of the vehicle as device dividing lines on the basis of an output of a detection device detecting surrounding conditions of the vehicle; recognize dividing lines defining the driving lane of the vehicle from map information as map dividing lines on the basis of position information of the vehicle; perform a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction seen from the vehicle, and if the results of the left side dividing line comparison and the right side dividing line comparison satisfy a specific condition, perform the left side dividing line comparison and the right side dividing line comparison at a second distance shorter than the first distance; and perform control of the vehicle on the basis of the comparison results, wherein the specific condition includes a condition in which a degree of discrepancy of only one of the results of the left side dividing line comparison and the right side dividing line comparison at the first distance is less than a threshold value.

(2): In the above aspect (1), the control of the vehicle includes driving control in a first driving mode and a second driving mode in which a degree of driving assistance is lower or tasks on an occupant of the vehicle are greater than in the first driving mode, and the processor continues the first driving mode if the first driving mode is being executed and the degree of discrepancy of any one of the results of the left side dividing line comparison and the right side dividing line comparison at the first distance is less than the threshold value.

(3): In the above aspect (2), the processor further executes instructions to: correct the map dividing lines on the basis of the device dividing lines, wherein the processor corrects the map dividing lines on the basis of the device dividing lines at the second distance if both degrees of discrepancy in the results of the left side dividing line comparison and the right side dividing line comparison at the second distance are less than the threshold value, and the processor performs the control of the vehicle on the basis of the map dividing lines corrected.

(4) in the above aspect (3), if at least one of the degrees of discrepancy is at least the threshold value in the results of the left side dividing line comparison and the right side dividing line comparison at the second distance, the processor corrects the map dividing line on the basis of the device dividing line at the first distance for a dividing line of left and right dividing lines of the driving lane whose degree of discrepancy is less than the threshold value at the first distance, and the processor performs the control of the vehicle on the basis of the map dividing line corrected.

(5): In the above aspect (2), the processor changes the control of the vehicle from the first driving mode to the second driving mode if the first driving mode is being executed and the degree of discrepancy of at least one of the results of the left side dividing line comparison and the right side dividing line comparison at the second distance is at least the threshold value.

(6): In the above aspect (2), the processor further executes instructions to: correct the map dividing lines on the basis of the device dividing lines, wherein if the degree of discrepancy of only one of the results of the left side dividing line comparison and the right side dividing line comparison at the second distance is less than the threshold value, the processor corrects the map dividing line on the basis of the device dividing line at the second distance for a dividing line of the left and right dividing lines whose degree of discrepancy at the first distance is less than the threshold value, and the processor performs the control of the vehicle on the basis of the map dividing line corrected.

(7): In the above aspect (6), if the dividing line of the left and right dividing lines whose degree of discrepancy at the second distance is less than the threshold value and the dividing line whose degree of discrepancy at the first distance is less than the threshold value are on the same side, the processor corrects the map dividing line on the basis of the device dividing line at the second distance for the dividing lines on the side on which the degrees of discrepancy of the left and right dividing lines are less than the threshold value.

(8): In the above aspect (1), the processor performs the control if a specific shape is present in the driving lane in the traveling direction of the vehicle, and the specific shape includes at least one of a branching road, a merging road, an increase or decrease in the number of lanes, an increase or decrease in lane width, and an intersection.

(9): In the above aspect (8), if the degree of discrepancy is at least the threshold value on the basis of the comparison results at the first distance for the dividing line of the left and right dividing lines on a side opposite to the side on which the specific shape is present, the processor performs the comparison at the second distance.

(10): In the above aspect (1), the control of the vehicle includes at least one of steering control of the vehicle, speed control, and display control of the driving lane or the dividing line defining the driving lane.

(11): A vehicle control method according to another aspect of the present invention in which a computer executes: recognizing left and right dividing lines seen from a vehicle defining a driving lane of the vehicle as device dividing lines on the basis of an output of a detection device detecting surrounding conditions of the vehicle; recognizing dividing lines defining the driving lane of the vehicle from map information as map dividing lines on the basis of position information of the vehicle; performing a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction seen from the vehicle, and if the results of the left side dividing line comparison and the right side dividing line comparison satisfy a specific condition, performing the left side dividing line comparison and the right side dividing line comparison at a second distance shorter than the first distance; and performing control of the vehicle on the basis of the comparison results, wherein the specific condition includes a condition in which a degree of discrepancy of only one of the results of the left side dividing line comparison and the right side dividing line comparison at the first distance is less than a threshold value.

(12): A computer-readable non-transitory storage medium storing a program according to another aspect of the present invention configured to cause a computer to execute: recognizing left and right dividing lines seen from a vehicle defining a driving lane of the vehicle as device dividing lines on the basis of an output of a detection device detecting surrounding conditions of the vehicle; recognizing dividing lines defining the driving lane of the vehicle from map information as map dividing lines on the basis of position information of the vehicle; performing a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction seen from the vehicle, and if the results of the left side dividing line comparison and the right side dividing line comparison satisfy a specific condition, performing the left side dividing line comparison and the right side dividing line comparison at a second distance shorter than the first distance; and performing control of the vehicle on the basis of the comparison results, wherein the specific condition includes a condition in which a degree of discrepancy of only one of the results of the left side dividing line comparison and the right side dividing line comparison at the first distance is less than a threshold value.

According to the aspects (1) to (12), it is possible to execute more appropriate driving control on the basis of the recognition results of road dividing lines.

### DESCRIPTION OF EMBODIMENTS

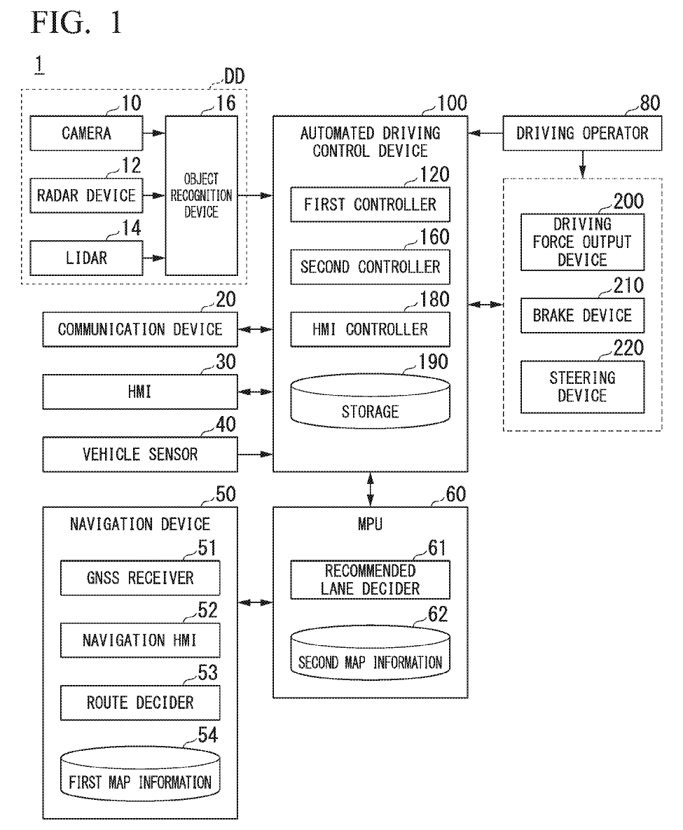

FIG. 1 is a configuration diagram of a vehicle system including a vehicle control device according to an embodiment.

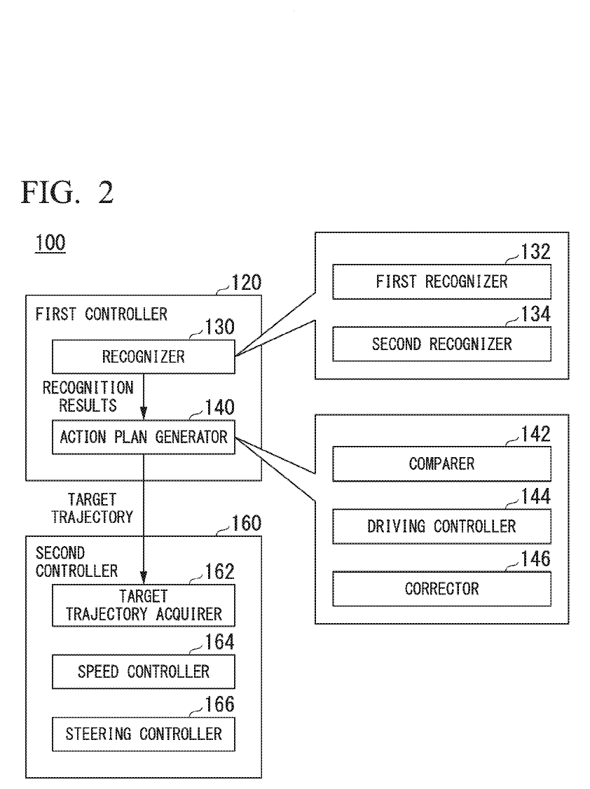

FIG. 2 is a functional configuration diagram of a first controller and a second controller.

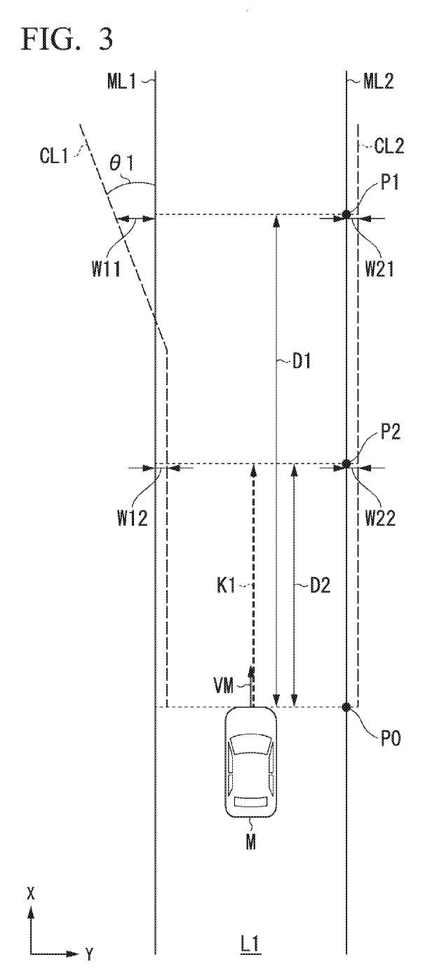

FIG. 3 is a diagram for describing driving control of a vehicle in a first scene.

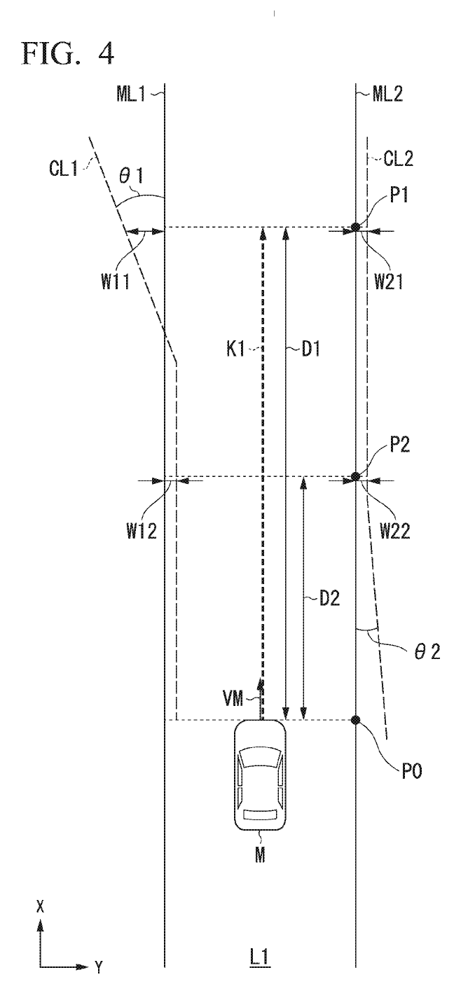

FIG. 4 is a diagram for describing driving control of the vehicle in a second scene.

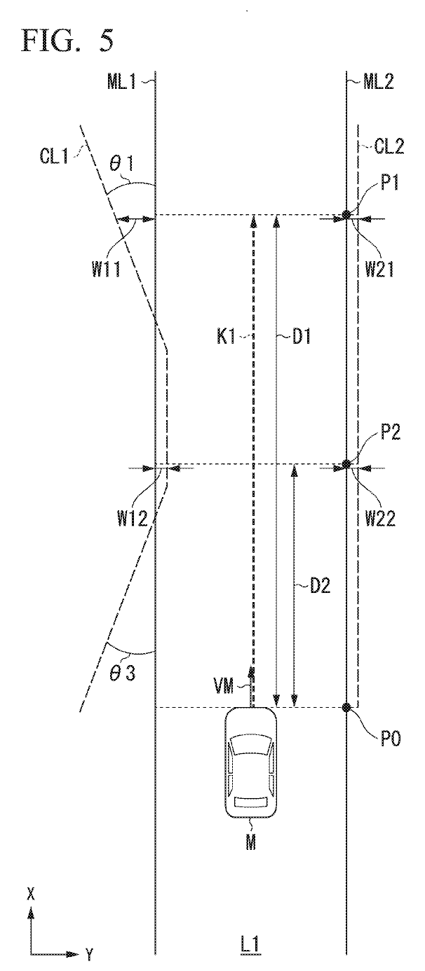

FIG. 5 is a diagram for describing driving control of the vehicle in a third scene.

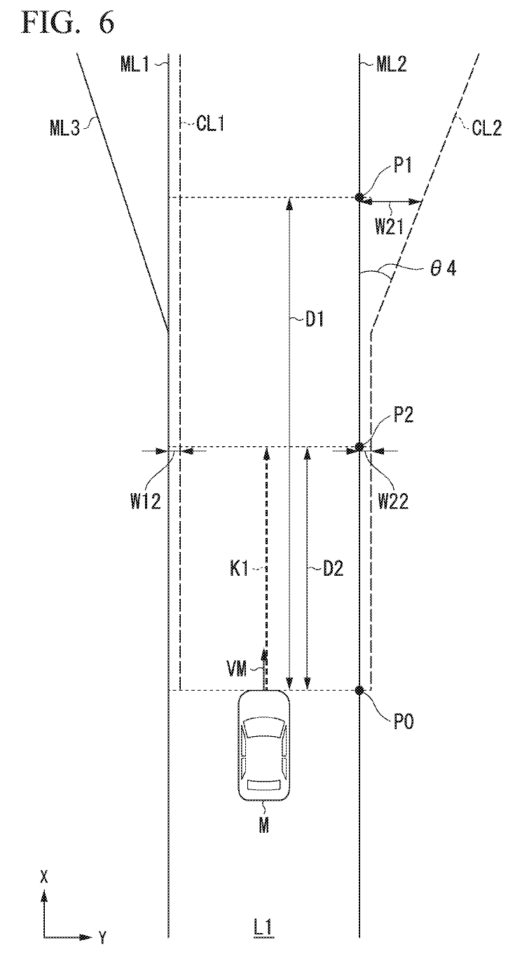

FIG. 6 is a diagram for describing driving control of the vehicle in a fourth scene.

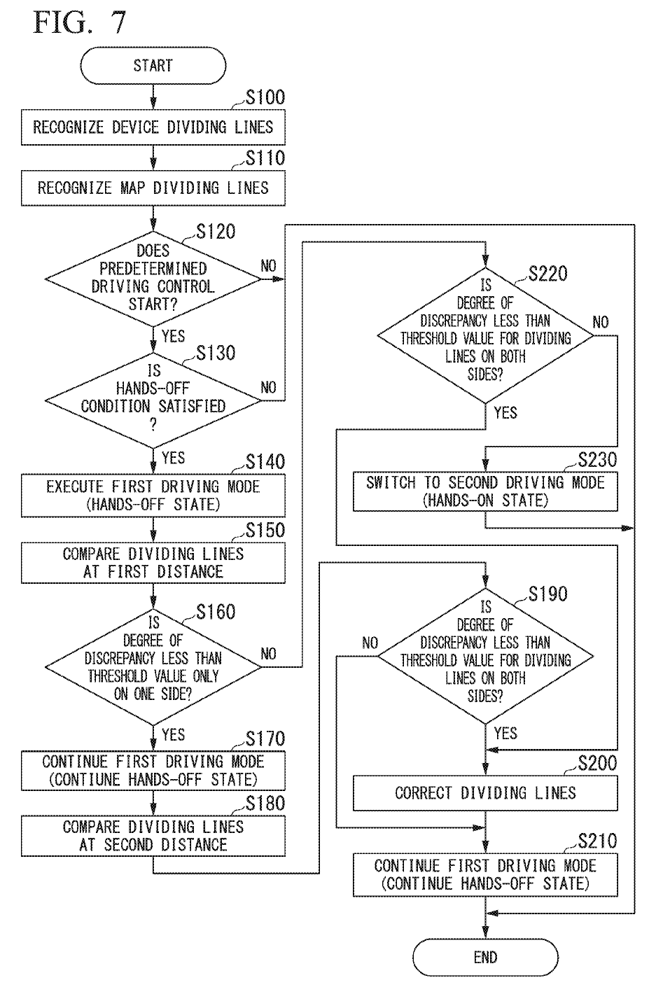

FIG. 7 is a flowchart showing an example of a flow of a driving control process in a first example.

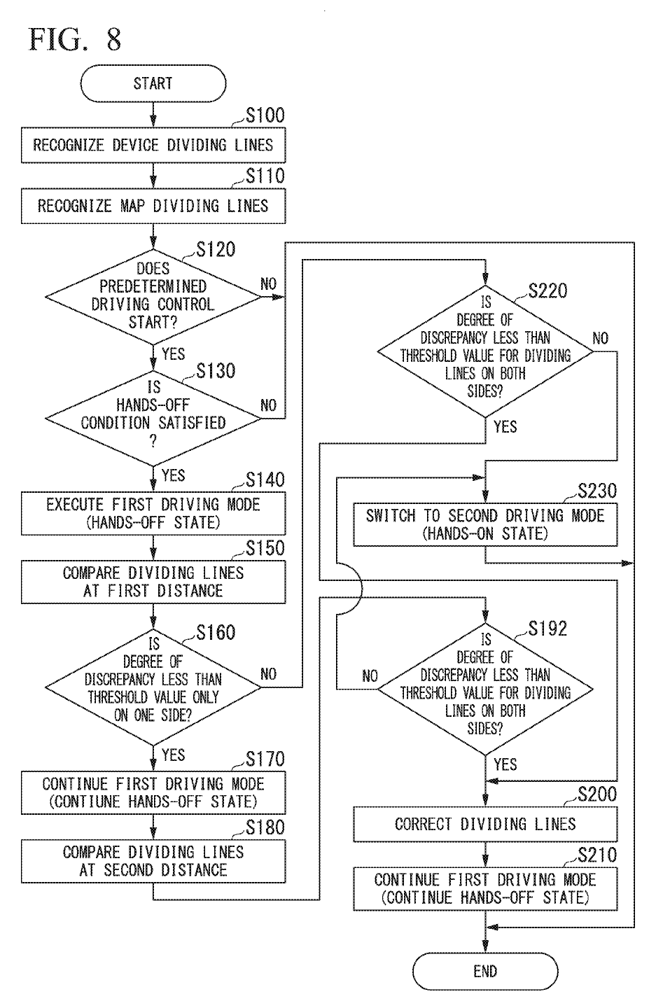

FIG. 8 is a flowchart showing an example of a flow of a driving control process in a second example.

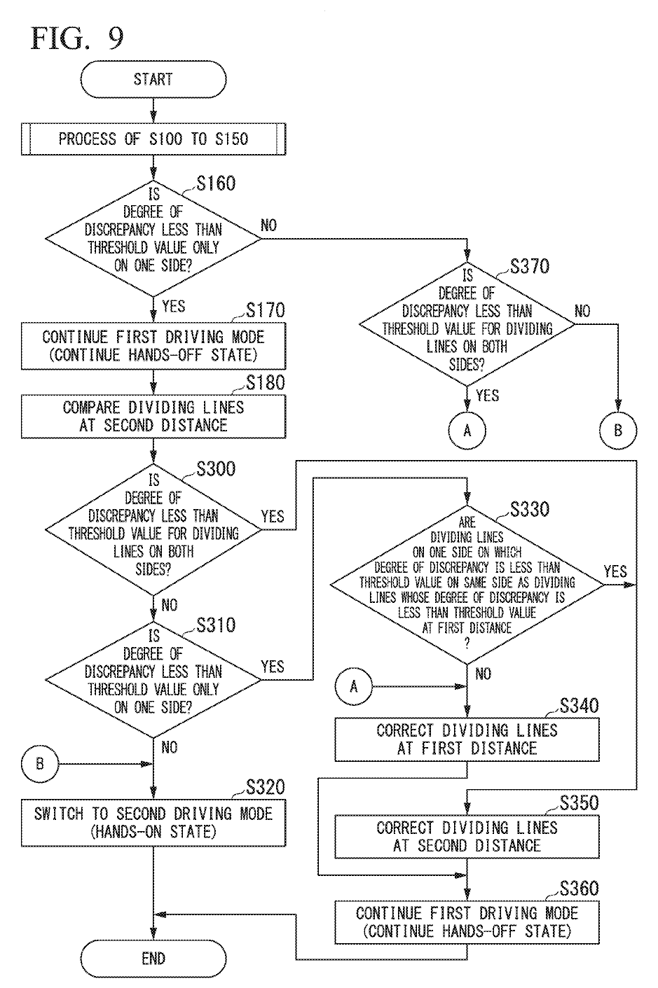

FIG. 9 is a flowchart showing an example of a flow of a driving control process in a first example.

### DESCRIPTION OF EMBODIMENT

Embodiments of a vehicle control device, a vehicle control method, and a storage medium of the present invention will be described below with reference to the drawings. In the following description, an embodiment in which the vehicle control device is applied to an automated driving vehicle will be described. Autonomous driving indicates, for example, automatically controlling one or both of steering and a speed of a vehicle to perform driving control. Examples of the above-described driving control may include various types of driving control, for example, an adaptive cruise control system (ACC), a lane keeping assistance system (LKAS), automated lane change (ALC), traffic jam pilot (TJP), collision mitigation brake system (CMBS), and the like. Also, for an automated driving vehicle, driving control may be performed by a manual operation of a user (for example, an occupant) of a vehicle (so-called manual driving). Further, the vehicle control device according to the embodiment may be applied, in addition to vehicles, for example, to mobile objects such as ships that can move on the ground like hovercrafts, aircraft that can travel on roads, and stand-up vehicles having a power unit.

### Overall Configuration

FIG. 1 is a configuration diagram of a vehicle system 1 including the vehicle control device according to the present embodiment. A vehicle (hereinafter referred to as a vehicle M) in which the vehicle system 1 is mounted is, for example, a vehicle such as a two-wheeled, three-wheeled, or four-wheeled vehicle or micromobility, and a drive source thereof is an internal combustion engine such as a diesel engine or a gasoline engine, an electric motor, or a combination of these. An electric motor operates using electric power generated by a generator connected to an internal combustion engine or discharged power from a battery (storage battery) such as a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automated driving control device 100, a driving force output device 200, a brake device 210, and a steering device 220. These devices and apparatuses are connected to each other via multiple communication lines such as a controller area network (CAN) communication line, serial communication lines, wireless communication networks, or the like. Further, the configuration shown in FIG. 1 is merely an example, and some of the configuration may be omitted, or other configurations may be further added. A combination of the camera 10, the radar device 12, the LIDAR 14, and the object recognition device 16 is an example of a “detection device DD.” The HMI 30 is an example of an “output device.” The automated driving control device 100 is an example of a “vehicle control device.”

The camera 10 is, for example, a digital camera using a solid-state image sensor such as a charge coupled device (CCD) or a complementary metal oxide semiconductor (CMOS). The camera 10 is attached to any location on the vehicle M in which the vehicle system 1 is mounted. In the case of imaging the front, the camera 10 is attached to an upper portion of a front windshield, a rear surface of a room mirror, a front head portion of a vehicle body, or the like. In the case of imaging the rear, the camera 10 is attached to an upper portion of a rear windshield, a back door, or the like. In the case of imaging the side, the camera 10 is attached to a door mirror, or the like. For example, the camera 10 periodically and repeatedly images surroundings of the vehicle M. The camera 10 may be a stereo camera.

The radar device 12 emits radio waves, such as millimeter waves, around the vehicle M and detects radio waves reflected by surrounding objects (reflected waves) to detect at least positions (distances and orientations) of the objects. The radar device 12 is attached to the vehicle M at any location. The radar device 12 may detect a position and a speed of an object using a frequency modulated continuous wave (FM-CW) method.

The LIDAR 14 emits light to the vicinity of the vehicle M and measures scattered light. The LIDAR 14 detects a distance to a target on the basis of the time between light emission and reception. The emitted light is, for example, pulsed laser light. The LIDAR 14 is attached to the vehicle M at any location.

The object recognition device 16 performs sensor fusion processing on detection results from some or all of the camera 10, the radar device 12, and the LIDAR 14 included in the detection device DD and recognizes a position, a type, a speed, or the like of the object. The object recognition device 16 outputs the recognition results to the automated driving control device 100. Also, the object recognition device 16 may output the detection results from the camera 10, the radar device 12, and the LIDAR 14 directly to the automated driving control device 100. In that case, the object recognition device 16 may be omitted from the configuration of the vehicle system 1 (detection device DD).

The communication device 20 uses, for example, a network such as a cellular network, a Wi-Fi network, Bluetooth (registered trademark), dedicated short range communication (DSRC), a local area network (LAN), a wide area network (WAN), or the Internet to communicate with, for example, other vehicles present around the vehicle M, a terminal device of a user using the vehicle M, or various server devices.

The HMI 30 outputs various types of information to an occupant (including a driver) of the vehicle M and receives an input operation performed by the occupant. The HMI 30 includes, for example, a display and a speaker. The display is, for example, a liquid crystal display (LCD), an organic electro luminescence (EL) display device, or the like. The display displays various images (including videos) in the embodiment. The display may be with integrated with an input as a touch panel. The speaker outputs a predetermined sound (for example, an alarm, a voice message, or the like). Further, in addition to (or instead of) the display and the speaker, the HMI 30 may be microphones, buzzers, touch panels, switches, keys, or the like. Examples of the switches include switches for executing or terminating predetermined driving control (for example, ACC or LKAS), or the like, which can be executed by a driving controller, which will be described later, and switches for approving (permitting) or rejecting driving control recommendations (suggestions) from the system (vehicle system 1) side. Also, examples of the switches may include switches for performing direction indicating operations (blinker switches), or the like.

The vehicle sensor 40 includes a vehicle speed sensor for detecting a speed of the vehicle M, an acceleration sensor for detecting an acceleration, a yaw rate sensor for detecting a yaw rate (for example, a rotational angular velocity around a vertical axis passing through a center of gravity point of the vehicle M), and a direction sensor for detecting an orientation of the vehicle M. Also, the vehicle sensor 40 may be provided with a position sensor for detecting a position of the vehicle. The position sensor is an example of a “position measurer.” The position sensor is, for example, a sensor for acquiring position information (longitude and latitude information) from a Global Positioning System (GPS) device. Further, the position sensor may be a sensor for acquiring the position information using a Global Navigation Satellite System (GNSS) receiver 51 of the navigation device 50. The vehicle sensor 40 may derive the speed of the vehicle M from a difference (that is, a distance) in the position information at a predetermined time in the position sensor. The results detected by the vehicle sensor 40 are output to the automated driving control device 100.

The navigation device 50 includes, for example, the GNSS receiver 51, a navigation HMI 52, and a route decider 53. The navigation device 50 stores first map information 54 in a storage device such as a hard disk drive (HDD) or a flash memory. The GNSS receiver 51 identifies a position of the vehicle M on the basis of signals received from a GNSS satellite. The position of the vehicle M may be identified or supplemented by an inertial navigation system (INS) that uses the output of the vehicle sensor 40. The navigation HMI 52 includes a display device, a speaker, a touch panel, keys, or the like. The GNSS receiver 51 may be provided in the vehicle sensor 40. The navigation HMI 52 may be partially or entirely shared with the above-described HMI 30. The route decider 53 decides, for example, a route (hereinafter, a route on a map) from a position of the vehicle M specified by the GNSS receiver 51 (or any input position) to a destination input by the occupant using the navigation HMI 52 with reference to the first map information 54. The first map information 54 is, for example, information in which road shapes are expressed by links indicating roads (an example of a moving path) and nodes connected by the links. The first map information 54 may include point of interest (POI) information, or the like. The route on the map is output to the MPU 60. The navigation device 50 may perform route guidance using the navigation HMI 52 on the basis of the route on the map. The navigation device 50 may transmit the current position and the destination to a navigation server via the communication device 20 and acquire a route equivalent to the route on the map from the navigation server. The navigation device 50 outputs the decided route on the map to the MPU 60.

The MPU 60 includes, for example, a recommended lane decider 61, and stores second map information 62 in a storage device such as an HDD or a flash memory. The recommended lane decider 61 divides the route on the map provided by the navigation device 50 into a number of blocks (for example, every 100 m in a traveling direction of the vehicle), and decides recommended lanes for each block with reference to the second map information 62. The recommended lane decider 61 decides in which lane from the left the vehicle travels. When there is a branch on the route on the map, the recommended lane decider 61 decides a recommended lane so that the vehicle M can travel along a reasonable route to proceed to a branch destination.

The second map information 62 is map information with higher accuracy than the first map information 54. The second map information 62 includes, for example, the number of lanes (the number of moving paths), types or shapes of road dividing lines (hereinafter referred to as dividing lines), information about centers of lanes, information about road boundaries, or the like. The second map information 62 may include information about whether or not the road boundaries are boundaries including a structure (physical boundary) through which the vehicle cannot pass (including cross or contact). Examples of the physical boundary may be, for example, a guardrail, a curb, a median strip, a fence, or the like. Also, the second map information 62 may include road shape information, traffic regulation information, address information (addresses and postal codes), facility information, parking lot information, telephone number information, or the like. The road shape information may be, for example, lane widths, gradients, branches, merging points, intersections, curvatures (which may be read as radii of curvature. The same applies below) of roads, amounts of curvature change, or the like. The second map information 62 may be updated (renewed) at any time by the communication device 20 communicating with an external device. The first map information 54 and the second map information 62 may be provided as an integrated piece of map information. In addition, the map information may be stored in a storage 190.

The driving operator 80 includes, for example, a steering wheel, an accelerator pedal, and a brake pedal. Also, The driving operator 80 may include a shift lever, a special steering wheel, a joystick, or other operators. For example, an operation detector that detects an amount of operation of an operator performed by the occupant or the presence or absence of an operation is attached to each operator of the driving operator 80. The operation detector detects, for example, a steering angle and a steering torque of the steering wheel, an amount of depression of the accelerator pedal or the brake pedal, or the like. In addition, the operation detector outputs detection results to the automated driving control device 100, or one of the driving force output device 200, the brake device 210, and the steering device 220, or both thereof.

The automated driving control device 100 executes various types of driving control relating to automated driving for the vehicle M. The automated driving control device 100 includes, for example, a first controller 120, a second controller 160, an HMI controller 180, and the storage 190. The first controller 120, the second controller 160, and the HMI controller 180 are each realized by, for example, a hardware processor such as a central processing unit (CPU) executing a program (software). Further, some or all of these constituent elements may be realized by hardware (including circuitry) such as a large scale integration (LSI), an application specific integrated circuit (ASIC), a field-programmable gate array (FPGA), a graphics processing unit (GPU), or a system on chip (SOC), or may be realized by software in cooperation with hardware. The above-described program may be stored in advance in a storage device (a storage device including a non-transitory storage medium) such as an HDD, a flash memory, or the like of the automated driving control device 100, or may be stored in a removable storage medium such as a DVD, a CD-ROM, or a memory card and installed in a storage device of the automated driving control device 100 by inserting the storage medium (non-transitory storage medium) into a drive device, a card slot, or the like.

The storage 190 may be realized by the above-described various storage devices, or an electrically erasable programmable read only memory (EEPROM), a read only memory (ROM), or a random access memory (RAM), or the like. The storage 190 stores, for example, various types of information, programs, or the like according to the embodiment. Also, the storage 190 may store the map information (for example, the first map information 54 and the second map information 62).

FIG. 2 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a pre-given model in parallel. For example, the function of “recognizing an intersection” may be realized by executing in parallel recognition of an intersection by deep learning or the like and recognition based on pre-given conditions (signals, road markings, or the like that can be pattern matched), and scoring and evaluating both of them comprehensively. This ensures reliability of the automated driving. In addition, the first controller 120 executes control relating to the automated driving of the vehicle M on the basis of, for example, instructions from the MPU 60, the HMI controller 180, or the like.

The recognizer 130 recognizes surrounding conditions of the vehicle M on the basis of recognition results of the detection device DD (information input from the camera 10, the radar device 12, and the LIDAR 14 via the object recognition device 16). For example, the recognizer 130 recognizes a state of the object present around (within a predetermined distance from) the vehicle M, such as a position, a speed, an acceleration, or the like of the object. Examples of the object include, for example, other vehicles, traffic participants such as pedestrians or bicycles, physical boundaries for dividing roads (moving paths), or the like. The position of the object is recognized as a position on absolute coordinates with a representative point (a center of gravity, a center of a drive shaft, or the like) of the vehicle M as the origin, and is used for control. The position of the object may be represented by a representative point such as a center of gravity or a corner of the object, or may be represented by a represented region. If the object is a mobile object such as another vehicle, the “state” of the object may include, for example, an acceleration, a jerk, or a “behavior state” (for example, whether another vehicle is changing lanes or is about to change lanes) of the mobile object.

In addition, the recognizer 130 recognizes, for example, stop lines, obstacles, red lights, toll booths, other road phenomena, markings on roads (speed limits), and road signs indicating speed limits. Also, the recognizer 130 includes, for example, a first recognizer 132 and a second recognizer 134. Details of these functions will be described below.

The action plan generator 140 generates an action plan for driving the vehicle M by automated driving on the basis of the recognition results of the recognizer 130, or the like. For example, the action plan generator 140 generates a target trajectory along which the vehicle M will automatically (without depending on a driver’s operation) travel in the future so that the vehicle M travels in principle along the recommended lanes decided by the recommended lane decider 61 and can cope with the surrounding conditions of the vehicle M on the basis of the recognition results by the recognizer 130, the surrounding road shapes based on the current position of the vehicle M acquired from the map information, and the like. The target trajectory includes, for example, a speed element. For example, the target trajectory is expressed as a path along which points (path points) to be reached by the vehicle M are arranged in order. The path points are points at which the vehicle M should arrive at each predetermined travel distance (for example, about a few meters) along the road, and separately, target speeds and target accelerations are generated as part of the target trajectory for each predetermined sampling time (for example, about a few decimal second). In addition, the path points may be positions at which the vehicle M should arrive at each predetermined sampling time. In this case, information about the target speeds and the target accelerations is expressed as intervals between the path points.

The action plan generator 140 may set automated driving events when the target trajectory is generated. Examples of the events include, for example, a constant speed traveling event in which the vehicle M is caused to travel in the same lane at a constant speed, a following traveling event corresponding to ACC in which the vehicle M follows another vehicle that is within a predetermined distance (for example, within 100 [m]) in front of the vehicle M and is closest to the vehicle M, a lane keeping traveling event corresponding to the LKAS in which the vehicle M is caused to travel in the center of the driving lane; a lane change event corresponding to ALC in which the vehicle M is caused to change lanes from the vehicle’s own lane to an adjacent lane, a branching event in which the vehicle M is caused to branch into a destination side lane at a road branch point, a joint event in which the vehicle M is caused to join a main lane at a joint point, a takeover event for terminating the automated driving and switching to manual driving, and the like. Examples of the events may include, for example, an overtaking event in which the vehicle M is first caused to change lanes to an adjacent lane, to overtake a forward vehicle along the adjacent lane, and then to change lanes back to the original lane, an avoidance event in which the vehicle M is caused to perform at least one of braking and steering to avoid an obstacle present in front of the vehicle M, and the like.

For example, the action plan generator 140 may change an event already decided for a current section to another event or set a new event for the current section in accordance with the surrounding conditions of the vehicle M recognized during traveling of the vehicle M. The action plan generator 140 may change an event already set for the current section to another event or set a new event for the current section in accordance with an operation of the occupant performed on the HMI 30. The action plan generator 140 generates the target trajectory in accordance with to the set event.

The action plan generator 140 includes, for example, a comparer 142, a driving controller 144, and a corrector 146. The driving controller 144 is an example of a “driving controller.” Details of these functions will be described below.

The second controller 160 controls the driving force output device 200, the brake device 210, and the steering device 220 so that the vehicle M passes through the target trajectory generated by the action plan generator 140 at the scheduled time.

The second controller 160 includes, for example, a target trajectory acquirer 162, a speed controller 164, and a steering controller 166. The target trajectory acquirer 162 acquires information about the target trajectory (path points) generated by the action plan generator 140 and stores it in a memory (not shown). The speed controller 164 controls the driving force output device 200 or the brake device 210 on the basis of speed elements associated with the target trajectory stored in the memory. The steering controller 166 controls the steering device 220 in accordance with a curved state of the target trajectory stored in the memory. The processing of the speed controller 164 and the steering controller 166 is realized, for example, by a combination of feedforward control and feedback control. As an example, the steering controller 166 executes a combination of feedforward control in accordance with a curvature of the road ahead of the vehicle M and feedback control based on discrepancy from the target trajectory.

Referring back to FIG. 1, the HMI controller 180 notifies the occupant of predetermined information via the HMI 30. The predetermined information includes, for example, information relating to traveling of the vehicle M, such as information about a state of the vehicle M and information about driving control. The information about the state of the vehicle M includes, for example, a speed, an engine speed, a shift position, or the like of the vehicle M. Also, the information about the driving control includes, for example, information for executing inquiry of the presence or absence of execution of driving control by automated driving and of whether or not automated driving is to be started, information about a driving control state by automated driving, information about driving modes, information for prompting the occupant to drive when driving is switched from automated driving to manual driving, or the like. In addition, the predetermined information may include information about the surrounding conditions recognized by the detection device DD. Further, the predetermined information may include information unrelating to traveling of the vehicle M, such as television programs, content (for example, movies) stored in a storage medium such as a DVD. Also, the predetermined information may include, for example, information about a current position or a destination in automated driving, and a remaining amount of fuel in the vehicle M. The HMI controller 180 may output the information received by the HMI 30 to the communication device 20, the navigation device 50, the first controller 120, or the like.

The HMI controller 180 may cause the HMI 30 to output inquiry information for the occupant, processing results by the first controller 120 and the second controller 160, or the like. The HMI controller 180 may transmit various types of information output by the HMI 30 to a terminal device used by the user of the vehicle M via the communication device 20.

The driving force output device 200 outputs a driving force (torque) for traveling the vehicle to driving wheels. The driving force output device 200 includes, for example, a combination of an internal combustion engine, an electric motor, a transmission, and the like, and an electronic control unit (ECU) that controls these. The ECU controls the above configuration in accordance with information input from the second controller 160 or information input from the accelerator pedal of the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with information input from the second controller 160 or information input from the brake pedal of the driving operator 80, so that a brake torque in accordance with a braking operation is output to each wheel. The brake device 210 may be provided with, as a backup, a mechanism that transmits a hydraulic pressure generated by operating the brake pedal to the cylinder via a master cylinder. Also, the brake device 210 is not limited to the configuration described above, and may be an electronically controlled hydraulic brake device that controls an actuator in accordance with the information input from the second controller 160 to transmit the hydraulic pressure of the master cylinder to the cylinder.

The steering device 220 includes, for example, a steering ECU and an electric motor. For example, the electric motor applies a force to a rack and pinion mechanism to change a direction of a steering wheel. The steering ECU drives the electric motor to change the direction of the steering wheel in accordance with the information input from the second controller 160 or information input from the steering wheel of the driving operator 80.

### Recognizer and Action Plan Generator

Next, details of functions of the recognizer 130 (mainly the first recognizer 132 and the second recognizer 134) and the action plan generator 140 (mainly the comparer 142, the driving controller 144, and the corrector 146) will be described. Also, in the following, the recognition results obtained by the recognizer 130 and the content of driving control based on the recognition results will be described in several different scenes.

### First Scene

FIG. 3 is a diagram for describing driving control of the vehicle M in a first scene. In the example of FIG. 3, device dividing lines CL1 and CL2 recognized by the detection device DD, and map dividing lines ML1 to ML2 obtained from the map information (for example, the second map information 62) on the basis of position information of the vehicle M are shown. For example, in the map information, a lane L1 is defined by the map dividing lines ML1 and ML2. The lane L1 is a lane along which traveling is possible in an extending direction (X axis direction in the figure). Also, when there is no need to distinguish between the device dividing lines CL1 and CL2, they may be referred to simply as “device dividing lines CL” and when there is no need to distinguish between the map dividing lines ML1 and ML2, they may be referred to simply as “map dividing lines ML.” Further, in the first scene shown in FIG. 3, the vehicle M is traveling on the lane L1 at a speed VM. Hereinafter, the lane L1 may be referred to as a “driving lane L1,” if needed.

In the first scene, the first recognizer 132 recognizes the surrounding conditions of the vehicle M on the basis of the output of the detection device DD, which detects the surrounding conditions (external world) of the vehicle M. For example, the first recognizer 132 recognizes left and right dividing lines seen from the vehicle M, which define the driving lane (lane L1) of the vehicle M, as the device dividing lines CL1 and CL2 on the basis of an image captured by the camera 10 (hereinafter referred to as a camera image). In the example of FIG. 3, the device dividing lines CL1 and CL2 in front of the vehicle M are shown, but side and rear device dividing lines CL1 and CL2 may also be recognized.

For example, the first recognizer 132 analyzes the camera image, extracts edge points in the image that have a large difference in brightness from adjacent pixels, and recognizes the device dividing lines CL1 and CL2 on an image plane by connecting the edge points to each other. Also, the first recognizer 132 converts positions of the device dividing lines CL1 and CL2 relative to a position of a representative point of the vehicle M into a vehicle coordinate system (for example, an XY plane coordinates in FIG. 3).

Also, the first recognizer 132 may recognize, for example, curvatures of the device dividing lines CL1 and CL2. In addition, the first recognizer 132 may recognize amounts of curvature change of the device dividing lines CL1 and CL2. The amounts of curvature change are, for example, change rates over time in the curvatures of the device dividing lines CL1 and CL2 recognized by the camera 10 x [m] ahead as viewed from the vehicle M. Further, the first recognizer 132 may recognize a curvature or an amount of curvature change of the lane defined by the device dividing lines CL1 and CL2 by averaging the curvatures or the amounts of curvature change of the device dividing lines CL1 and CL2. The device dividing lines CL1 and CL2 may be recognized or corrected on the basis of the output of the detection device other than the camera 10 (for example, the radar device 12 or the LIDAR 14).

The second recognizer 134 recognizes dividing lines of the lane around the vehicle M from the map information on the basis of, for example, the position of vehicle M detected by the vehicle sensor 40 or the GNSS receiver 51. For example, the second recognizer 134 refers to the map information on the basis of the position information of the vehicle M and recognizes the left and right dividing lines of the vehicle M that defines the driving lane L1 of the vehicle M as the map dividing lines ML1 and ML2.

Also, the second recognizer 134 recognizes curvatures or amounts of curvature change of each of the map dividing lines ML1 to ML2 from the second map information 62. In addition, the second recognizer 134 may recognize the curvature or the amount of curvature change of the driving lane L1 by averaging the curvatures or the amounts of curvature change of the map dividing lines ML1 and ML2.

The comparer 142 compares the device dividing lines CL1 and CL2 recognized by the first recognizer 132 with the map dividing lines ML1 and ML2 recognized by the second recognizer 134. For example, the comparer 142 first performs the above comparison at a far position in the traveling direction seen from the vehicle M, and performs the above comparison at a near position on the basis of the comparison results. Specifically, the comparer 142 performs a left side dividing line comparison for comparing the device dividing line CL1 that defines a left side of the driving lane L1 with the map dividing line ML1, and a right side dividing line comparison for comparing the device dividing line CL2 that defines a right side of the driving lane L1 with the map dividing line ML2 at a first distance D1 in the traveling direction (forward) from the current position of the vehicle M (point P0 in the figure). Here, the comparison at the first distance D1 is a comparison near a point P1, which is the first distance D1 away from the vehicle M in the traveling direction (or may be a comparison in a section from the point P0 to the point P1), and may include a predetermined allowable error range. Also, the comparison at the first distance D1 may be a comparison in a section from a second distance D2, which will be described later, to the first distance D1 (a section from a point P2 to the point P1).

For example, as the left side dividing line comparison at the first distance D1, the comparer 142 compares, for example, at least one of the positions, extending directions (angles), curvatures, amounts of curvature change, and the like between the device dividing line CL1 and the map dividing line ML1. For example, the comparer 142 superimposes the device dividing line CL1 and the map dividing line ML1 on the vehicle coordinate system plane (XY plane) using the position of the representative point of the vehicle M as a reference, compares lateral positions (in a lane width direction, which is a Y axis direction in the figure) of the device dividing line CL1 and the map dividing line ML1, and acquires an amount of deviation W11. Also, the comparer 142 may compare the respective extending directions of the device dividing line CL1 and the map dividing line ML1 and acquire a deviation angle θ1 between the dividing lines. Further, the comparer 142 may compare the curvatures or the amounts of curvature change of the device dividing line CL1 and the map dividing line ML1 and acquire a degree (magnitude) of difference. In addition, the comparer 142 may acquire a degree of discrepancy on the basis of the degree of difference in the amount of deviation W11, the deviation angle θ1, and the curvatures or amounts of curvature change. In this case, as the amount of deviation W11 increases, the deviation angle θ1 increases, or as the degree of difference increases, the degree of discrepancy increases.

Also, similarly to the left side dividing line comparison, as the right side dividing line comparison at the first distance D1, the comparer 142 compares at least one of the positions (amount of deviation W21 in the figure), the extending directions (angles), the curvatures or amounts of curvature change, and the like of the device dividing line CL2 and the map dividing line ML2 and acquires the degree of discrepancy.

In addition, if the results of the above-described left side dividing line comparison and right side dividing line comparison satisfy a specific condition, the comparer 142 performs the left side dividing line comparison and the right side dividing line comparison at the second distance D2, which is shorter than the first distance D1. For example, the specific condition includes that the degree of discrepancy of either the left side dividing line comparison or the right side dividing line comparison at the first distance D1 is less than a threshold value. That is, the case of satisfying the specific condition is a case in which the degree of discrepancy of only one of the left side dividing line and the right side dividing line is less than the threshold value (and the degree of discrepancy of the other is at least the threshold value). Here, the comparison at the second distance D2 is a comparison near the point P2, which is the second distance D2 away in the traveling direction when seen from the vehicle M, and may include a predetermined allowable error range. Further, the comparison at the second distance D2 may be a comparison in a section from the current position of the vehicle M to the second distance D2 (a section from the point P0 to the point P2).

In the example of FIG. 3, since the degree of discrepancy of the left side dividing line is at least the threshold value and the degree of discrepancy of the right side dividing line is less than the threshold value, the specific condition is assumed to be satisfied. In this case, at the second distance D2, which is shorter than the first distance D1, the comparer 142 performs the left side dividing line comparison and the right side dividing line comparison (for example, comparison of the amounts of deviation W12 and W22, the deviation angles, the curvatures or amounts of curvature change, and the like in the figure) in the same manner as described above. Also, the first distances D1 and the second distance D2 may be fixed distances or variable distances depending on the speed VM of the vehicle M and the road shapes (for example, presence or absence of branches or merges, curvatures, amounts of curvature change, and the like). In addition, the first distance D1 may be a performance limit distance (recognizable limit distance) of the detection device DD. Further, the second distance D2 may be a distance obtained by subtracting a fixed distance from the first distance D1.

The driving controller 144 performs control (driving control) of the vehicle M on the basis of the recognition results of the first recognizer 132 and the second recognizer 134 and the comparison results performed by the comparer 142. For example, the driving controller 144 decides the driving control for the vehicle M on the basis of the above recognition results and comparison results, and generates the target trajectory on the basis of the decided driving control. “Deciding driving control” may include, for example, deciding the content (type) of driving control or deciding whether or not to execute (curb) driving control. Also, “executing driving control” may include, for example, switching the content of driving control and executing it, as well as continuing driving control that is already being executed. “Curbing driving control” may include not only not executing driving control, but also lowering a driving control mode (automation level).

Here, the driving control includes a first driving mode and a second driving mode in which a degree of driving assistance is lower than in the first driving mode or a task on the occupant of the vehicle M is greater than in the first driving mode. A lower degree of driving assistance indicates, for example, a lower degree of automation in driving control. A lower degree of automation indicates, for example, that the automated driving control device 100 has a lower degree of control over the steering or speed of the vehicle M (the driver is highly required to intervene in steering or acceleration or deceleration operations). A greater task on an occupant includes, for example, a large number of tasks or a heavy task imposed on the occupant. Examples of the task include, for example, monitoring surroundings of the vehicle M and the occupant’s operation of the driving operator 80. The operation of the driving operator includes, for example, a state in which the driver grips the steering wheel (hereinafter, a hands-on state). Also, the driving control may include a third driving mode and the like in which the degree of driving assistance is lower than in the second driving mode or the task on the occupants of the vehicle M is greater than in the second driving mode. Further, the driving mode with the lowest degree of driving assistance or the greatest task on the occupant of the vehicle M may be a manual driving mode (a mode in which no driving control is executed).

For example, the first driving mode allows driving control (for example, ACC, LKAS, ALC, TJP, CMBS, and the like) with no (or the lightest) task on the occupant in a state in which, for example, the occupant of the vehicle M is not gripping the steering wheel (hereafter, hands-off state). Also, in the second driving mode, the tasks imposed on the occupant may include, for example, monitoring the surroundings of the vehicle M and keeping the hands-on state.

For example, the driving controller 144 continues the first driving mode, for example, when the degrees of discrepancy of both dividing lines are less than the threshold value as a result of the left side dividing line comparison and the right side dividing line comparison at the first distance D1 during execution of the first driving mode (for example, driving control in the hands-off state). For example, if LKAS for driving in a center of the driving lane L1 is being executed as the first driving mode, the driving controller 144 causes the second controller 160 to execute control so that the target trajectory for driving in the center of the driving lane L1 on the basis of the device dividing lines CL1 and CL2 or the map dividing lines ML1 and ML2 is generated, and driving is performed along the generated target trajectory K1.

Also, in the embodiment, the corrector 146 may correct the map dividing lines ML before the driving controller 144 generates the target trajectory K1. For example, if the degrees of discrepancy of both dividing lines are less than the threshold value at the first distance D1 as described above, the corrector 146 corrects the position of the map dividing line ML1 to match the position of the device dividing line CL1 in the section from the vehicle M to the first distance D1 (point P1), and also corrects the position of the map dividing line ML2 to match the position of the device dividing line CL2. Correction of position may be, for example, correction of the amount of deviation in a lateral direction (the lane width direction) of each dividing line, correction of the deviation angle, or correction of the curvature or amount of curvature change. Correcting to match indicates correcting so that the positions of the dividing lines are aligned with (overlap) each other and correcting so that the degrees of discrepancy are within the allowable range smaller than the threshold value. Further, instead of correcting each of the map dividing lines ML1 and ML2, the corrector 146 may correct the position of the lane L1 or the entire map information. The driving controller 144 can generate a more appropriate target trajectory K1 using the corrected map dividing lines ML1 and ML2, and can use this target trajectory K1 to achieve more appropriate driving control.

Also, If the degrees of discrepancy of both dividing lines are less than the threshold value as a result of the left side dividing line comparison and the right side dividing line comparison at the first distance D1 during execution of the second driving mode, the driving controller 144 may perform control to switch from the second driving mode to the first driving mode. In addition, in the case of switching control, the driving controller 144 may cause the HMI 30 output information informing the occupant that switching is possible or inquiring whether or not to switch, and may switch the driving mode when information indicating permission to switch is received from the occupant. Further, after an instruction to switch to the first driving mode is received from the HMI 30, the driving controller 144 may switch from the second driving mode to the first driving mode at a timing when the degrees of discrepancy of the left and right dividing lines become less than the threshold value. Moreover, if the degrees of discrepancy of both dividing lines are all at least the threshold value in the results of the left side dividing line comparison and the right side dividing line comparison at the first distance D1, the driving controller 144 may curb the driving control in the first driving mode.

Also, for example, the driving controller 144 may continue the first driving mode even if the results of the left side dividing line comparison and the right side dividing line comparison at the first distance D1 satisfy the specific condition, as shown in FIG. 3, during the execution of the first driving mode. In addition, if the degree of discrepancy for at least one of them is less than the threshold value, for example, on the basis of a distance in the lateral direction (lane width direction) between that dividing line and the vehicle M, the other dividing line can be set at a position offset by the same distance toward the other side, thereby driving the vehicle M. For that reason, even in such a case, the hands-off state can be maintained, improving the continuity of driving control. Further, if the above specific condition is satisfied during the execution of the second driving mode, the driving controller 144 may not switch to the first driving mode, or may determine whether or not to switch depending on the comparison results at the second distance D2.

For example, as shown in FIG. 3, if the results of the left side dividing line comparison and the right side dividing line comparison at the first distance D1 satisfy the specific condition, and if the degrees of discrepancy of the left and right dividing lines are less than the threshold value from the results of the left side dividing line comparison and the right side dividing line comparison at the second distance D2, the corrector 146 corrects the position of the map dividing line ML1 to match the position of the device dividing line CL1 in the section from the current position of the vehicle M to the second distance D2, and also corrects the position of the map dividing line ML2 to match the position of the device dividing line CL2. Then, the driving controller 144 performs control of the vehicle M (for example, driving control using the first driving mode such as LKAS) on the basis of the map dividing lines ML1 and ML2 corrected by the corrector 146.

For example, recognition errors are more likely to occur at a far distance (first distance D1) from the vehicle M than at a close distance (second distance D2). Accordingly, in the embodiment, as shown in FIG. 3, even if one of the degrees of discrepancy between the device dividing lines CL and the map dividing lines ML at a far distance from the vehicle M are at least the threshold value, when the degrees of discrepancy between the device dividing lines CL and the map dividing lines ML at a close distance from the vehicle M are less than the threshold, by correcting the positions of the map dividing lines ML1 and ML2 at the close distance, it is possible to more accurately recognize the left and right dividing lines and perform driving control based on the recognition results. In the comparison between the degrees of discrepancy and the threshold value, the threshold value for the comparison of the first distance D1 and the threshold value for the comparison of the second distance D2 may be different values.

### Second Scene

Next, a second scene will be described. FIG. 4 is a diagram for describing driving control of the vehicle M in the second scene. The second scene differs from the first scene in that, at the second distance D2, the degree of discrepancy between the device dividing line CL2 and the map dividing line ML2 (for example, the degree of discrepancy based on the amount of deviation W22, the deviation angle θ2, or the like) is at least the threshold value. That is, in the second scene, the degree of discrepancy between the device dividing line CL1 and the map dividing line ML1 is at least the threshold value at the first distance D1, and the degree of discrepancy between the device dividing line CL2 and the map dividing line ML2 is at least the threshold value at the second distance D2.

In the second scene, as shown in FIG. 4, in the results of the left side dividing line comparison and the right side dividing line comparison at the second distance D2, if the degree of discrepancy of only one (the right side dividing line in FIG. 4) of them is at least the threshold value, and the degree of discrepancy at the first distance D1 of the dividing line on the same side as the dividing line whose degree of discrepancy is at least the threshold value is less than the threshold value, the map dividing line ML2 is corrected on the basis of the device dividing line CL2 at the first distance D1. In this case, the corrector 146 corrects the position of the map dividing line ML2 in the section from the point P2 to the point P1 to match the position of the device dividing line CL2 in the same section. This correction also corrects the position of the map dividing line ML2 in the section from the current position of the vehicle M to the second distance D2 (the section from the point P0 to the point P2).

Also, in the example of FIG. 4, the degree of discrepancy is less than the threshold value in the results of the left side dividing line comparison at the second distance D2. Accordingly, the corrector 146 may correct the position of the map dividing line ML1 in the section from the current position of the vehicle M to the second distance D2 (the section from the point P0 to the point P2) to match the position of the device dividing line CL1 in the same section. Thus, in the second scene, if the first driving mode is being executed, the target trajectory K1 can be generated on the basis of the corrected map dividing lines ML.

Also, if the first driving mode is being executed and the degrees of discrepancy of both dividing lines in the results of the left side dividing line comparison and the right side dividing line comparison at the second distance D2 are at least the threshold value, the corrector 146 may not perform any correction of the dividing lines. Even in this case, for example, the driving controller 144 can generate the target trajectory K1 on the basis of the device dividing lines CL and continue the first driving mode on the basis of the generated target trajectory K1. Further, instead of not performing correction, if the degree of discrepancy at the first distance D1 is less than the threshold value, the corrector 146 may correct the position of the map dividing lines ML at the first distance D1 on the basis of the position of the device dividing lines CL at the first distance D1, and generate the target trajectory K1 on the basis of the corrected map dividing line

Then, the driving controller 144 performs the control of the vehicle M on the basis of the map dividing lines ML corrected by the corrector 146. In this way, even if a situation like the second scene occurs while the first driving mode is being executed, the first driving mode (hands-off state) can be continued, thereby improving the continuity of driving control.

Also, In the embodiment, in the case of a situation such as the second scene, the driving controller 144 may perform control to switch to the second driving mode (hands-on state) instead of continuing the first driving mode (hands-off state). For example, if the first driving mode is being executed and the degree of discrepancy of at least one of the results of the left side dividing line comparison and the right side dividing line comparison at the second distance D2 is at least the threshold value, the driving controller 144 changes the control of the vehicle M from the first driving mode to the second driving mode. For example, when a degree of discrepancy of a dividing line is at least a threshold value at a close distance at which recognition accuracy is high, even if a degree of discrepancy is less than the threshold value at a far distance, switching to a hands-on state can further improve safety.

Also, whether or not to continue the first driving mode (hands-off state) or switch to the second driving mode (hands-on state) in a situation such as the second scene may be set, for example, on the basis of a magnitude of the degree of discrepancy, or may be set on the basis of the surrounding conditions of the vehicle M recognized by the first recognizer 132. For example, even if the degree of discrepancy at the second distance D2 is at least the threshold value, but less than a limit value, the first driving mode is continued after the corrector 146 has performed the correction, and if the degree of discrepancy is at least the limit value, the driving mode is switched to the second driving mode. In addition, if at least a predetermined number of other vehicles are present around (within a predetermined distance of) the vehicle M or if the road shape is difficult to recognize (for example, a curved road), the driving mode is switched to the second driving mode, and if other vehicles are less than a predetermined number or the road shape is easy to recognize, the first driving mode is continued. In this way, more appropriate driving control can be performed depending on the recognition status and surrounding conditions.

### Third Scene

Next, a third scene will be described. FIG. 5 is a diagram for describing driving control of the vehicle in the third scene. The example of FIG. 5 differs from the example of FIG. 3 in that, at the second distance D2, the degree of discrepancy between the device dividing line CL1 and the map dividing line ML1 (for example, the degree of discrepancy based on the amount of deviation W12, the deviation angle θ3, or the like) is at least the threshold value. That is, in the third scene, at both the first distance D1 and the second distance D2, the degree of discrepancy between the device dividing line CL1 and the map dividing line ML1 is at least the threshold value, and the degree of discrepancy between the device dividing line CL2 and the map dividing line ML2 is less than the threshold value. Also, in other words, the third scene occurs when, at the second distance D2, the degree of discrepancy only one of them in the results of the left side dividing line comparison and the right side dividing line comparison is less than the threshold value, and when the dividing line of the left and right dividing lines on the side on which the degree of discrepancy at the second distance D2 is less than the threshold value and the dividing line on the side on which the degree of discrepancy at the first distance D1 is less than the threshold value are the same.

In this case, the corrector 146 corrects the map dividing line ML2 on the basis of the device dividing line CL2 at the second distance D2 for the dividing lines on the side on which the degrees of discrepancy of the left and right dividing lines are less than the threshold value. Recognition accuracy is higher at a close distance than at a far distance, and thus, by correcting the map dividing line ML2 on the basis of the device dividing line CL2 at the second distance D2, it is possible to perform more accurate correction.

Then, the driving controller 144 performs the control of the vehicle M on the basis of the map dividing line ML2 corrected by the corrector 146. In this case, for example, the driving controller 144 acquires a lateral positional distance from the vehicle M to the map dividing line ML2, sets the left side dividing line at a position away from the vehicle M to the left by the lateral positional distance, generates the target trajectory K1 so that the vehicle M travels in the center of the lane demarcated by the left and right dividing lines, and causes the second controller 160 to execute the driving control to cause the vehicle M to travel along the generated target trajectory K1. As shown in the third scene, if the degree of discrepancy of one of the dividing lines is less than the threshold value at both the first distance D1 and the second distance D2, by making corrections in accordance with the positions of the dividing lines at the second distance D2, more accurate corrections can be made, and by generating the target trajectory K1 on the basis of the corrected dividing lines, more appropriate driving control can be realized.

In the case of the third scene, if the degree of discrepancy of only one of the left and right dividing lines is less than the threshold value in the results of the left side dividing line comparison and the right side dividing line comparison at the second distance D2, the corrector 146 may perform control of correcting the map dividing line on the basis of the device dividing line at the second distance D2 of the dividing lines on the side on which the degree of discrepancy at the first distance D1 is less than the threshold value among the left or right dividing lines.

### Fourth Scene

Next, a fourth scene will be described. FIG. 6 is a diagram for describing driving control of the vehicle M in the fourth scene. The fourth scene shows a situation in which a specific road shape exists near the first distance D1. The specific road shape is a shape in which the positions, orientations (extension directions), or the like of the dividing lines are expected to change, and includes, for example, at least one of a branching road, a merging road, an increase or decrease in the number of lanes, an increase or decrease in lane width, and an intersection (also including a T-intersection or the like) The example of FIG. 6 shows a branching road as an example of the specific road shape. On the branching road, in addition to the dividing lines that define the driving lane L1, there are also dividing lines defining the branching road. In the example of FIG. 6, in addition to the map dividing lines ML1 and ML2, a map dividing line ML3 is shown, which is one of the dividing lines defining the branching road.

In the fourth scene, if the recognition results of the first recognizer 132 or the second recognizer 134 indicate that a specific road shape exists in the driving lane L1 in the traveling direction of the vehicle M, the comparer 142 performs the comparison at the first distance D1 for the dividing lines (right side dividing lines in the figure) on a side opposite to the dividing lines (left side dividing line in the figure) on a side on which the specific road shape exists. Then, if the degree of discrepancy is at least the threshold value in the comparison results, the comparison of the left and right dividing lines at the second distance D2 is performed. In the example of FIG. 6, the comparison of the dividing lines at the second distance D2 is performed, and the degrees of discrepancy of both left and right dividing lines are less than the threshold value. In this case, the corrector 146 corrects the map dividing lines ML1 and ML2 on the basis of the device dividing lines CL1 and CL2 at the second distance D2. Then, the driving controller 144 generates the target trajectory K1 on the basis of the corrected map dividing lines ML1 and ML2. Thus, for example, if the first driving mode is being executed, the first driving mode can be continued for at least the section up to the second distance D2.

As shown in the fourth scene, if the specific road shape such as a branch or a merge is present near the first distance D1, the degrees of discrepancy between the device dividing lines CL and the map dividing lines ML are highly likely to be at least the threshold value. For that reason, in such a case, the dividing lines are compared in the section up to the second distance D2, and if the degree of discrepancy is less than the threshold value, the driving control in that section can be made continuous. Accordingly, the above-described control allows for the continuity of driving control for the specific road shape.

Also, for example, the control in the first through fourth scenes described above is repeatedly executed in a predetermined interval, and thus, after the vehicle M has traveled the second distance D2, on the basis of that position, a comparison based on the first distance D1 and the second distance D2 and control based on the comparison results are executed.

Further, the driving control executed in the first through fourth scenes described above may include not only continuing the first driving mode and switching between the first driving mode and the second driving mode, but also control of starting and ending predetermined driving control (for example, LKAS, ACC, or the like). In addition, the driving control executed may be at least one of steering control and speed control of vehicle M, may be display control in which the HMI controller 180 displays information on a display of the HMI 30, such as information about the driving lane of the vehicle M and the dividing lines defining the driving lane (for example, the recognition results or the comparison results of the dividing lines), or may include both of these.

### Process Flow

A process executed by the automated driving control device 100 of the embodiment will be described below. The following description will be made, primarily focusing on a driving control process based on the recognition results or the like of the dividing lines among the processes executed by the automated driving control device 100. The process shown below may be repeatedly executed at predetermined timing or at predetermined intervals. Also, in the following, the driving control process according to the embodiment will be described in several examples.

### Driving Control Process in First Example

FIG. 7 is a flowchart showing an example of a flow of a driving control process in a first example. In the example of FIG. 7, the first recognizer 132 recognizes the surrounding conditions, including the dividing lines (device dividing lines CL) present around the vehicle M on the basis of the output of the detection device DD that has detected the surrounding conditions of the vehicle M (step S100). Next, the second recognizer 134 refers to the map information on the basis of the position information of the vehicle M and recognizes the dividing lines (map dividing lines ML) present around the vehicle M from the map information (step S110).

Next, the driving controller 144 determines whether or not to start predetermined driving control (step S120). The predetermined driving control is driving control in which the steering, speed, and the like of the vehicle M are controlled on the basis of the recognized dividing lines, and includes, for example, ACC, LKAS, or the like. The predetermined driving control may be started, for example, when an instruction to execute the predetermined driving control is received via an operation of the HMI 30 executed by the occupant of the vehicle M, or when the surrounding conditions recognized by the first recognizer 132 satisfy conditions for starting the predetermined driving control. If the predetermined driving control is determined to start, the driving controller 144 determines whether or not hands-off conditions are satisfied (step S130). The hands-off conditions are conditions for executing the driving control in the hands-off state (first driving mode), and include, for example, in the case of LKAS, recognition of at least one of the left and right dividing lines, a time to contact TTC with a nearby obstacle (another vehicle or the like) being equal to or greater than a predetermined time, or the like, but are not limited thereto. Also, the time to contact TTC is calculated, for example, by dividing a relative distance by a relative speed in a relationship between the vehicle M and an obstacle.

If the hands-off conditions are determined to be satisfied, the driving controller 144 starts the first driving mode in which the hands-off state is possible (step S140). In the process of step S140, for example, if LKAS is executed as the first driving mode, the driving controller 144 generates a target trajectory for the vehicle M to pass through the center of the driving lane L1 defined by the recognized left and right device dividing lines CL or map dividing lines ML, and causes the second controller 160 to execute steering control and speed control of the vehicle M to travel along the generated target trajectory.

Next, the comparer 142 compares the dividing lines (the device dividing lines CL and the map dividing lines ML) present on each of the left and right sides of the vehicle M at the first distance D1 (step S150), and determines whether or not the degree of discrepancy of only one side is less than the threshold value (step S160). If the degree of discrepancy of only one side is determined to be less than the threshold value, the driving controller 144 continues the driving control in the first driving mode (hands-off state) (step S170). Also, the comparer 142 compares the dividing lines at the second distance D2, which is shorter (closer to the vehicle M) than the first distance D1 (step S180), and determines whether or not the degree of discrepancy is less than the threshold value for the dividing lines on both sides (step S190). If the degree of discrepancy is determined to be less than the threshold value for the dividing lines on both sides, the corrector 146 corrects each of the left and right map dividing lines ML to match the positions of the corresponding left and right device dividing lines CL (step S200). Next, the driving controller 144 continues the driving control in the first driving mode (hands-off state) on the basis of the corrected map dividing line positions (step S210).

In addition, if it is not determined in the process of step S190 that the degree of discrepancy is not less than the threshold value for the dividing lines on both sides, the driving control in the first driving mode (hands-off state) is continued on the basis of the device dividing lines CL, for example, without correcting the dividing lines (step S210).

Also, if it is determined in the process of step S160 that the degree of discrepancy only on one side is not less than the threshold value, the comparer 142 determines whether or not the degree of discrepancy is less than the threshold value for the dividing lines on both sides at the first distance D1 (step S220). If the degree of discrepancy is determined to be less than the threshold value for the dividing lines on both sides, steps S200 and S210 are executed, and if it is determined that the degree of discrepancy is not less than the threshold value for the dividing lines on both sides, the driving controller 144 performs control to switch from the first driving mode to the second driving mode, which is the hands-on state (step S230). Thus, the process of this flowchart ends.

Further, if it is determined in the process of step S120 that the predetermined driving control does not start, or if it is determined in the process of step S130 that hands-on conditions are not satisfied, the process of this flowchart ends.

### Driving Control Process in Second Example

FIG. 8 is a flowchart showing an example of a flow of a driving control process in a second example. The process shown in FIG. 8 differs from the process of steps S100 to S230, which is the driving control process in the first example shown in FIG. 7, in that the process of step S192 is included instead of the process of step S190. Accordingly, the following description will made mainly focusing on the process of step S192, and other descriptions will be omitted.

After the process of step S180 in FIG. 8, the comparer 142 determines whether or not the degree of discrepancy is less than the threshold value for the dividing lines on both sides (step S192), and if the degree of discrepancy is determined to be less than the threshold value, the process of steps S200 and S210 is performed. On the other hand, if it is determined that the degree of discrepancy is not less than the threshold value, the driving controller 144 proceeds to step S230 and performs control to switch to the second driving mode, which is in the hands-on state. The control according to the second example can achieve safer driving control when the left and right side dividing lines do not match at the second distance D2.

### Driving Control Process in Third Example

FIG. 9 is a flowchart showing an example of a flow of a driving control process in a third example. The process shown in FIG. 9 differs from the process of steps S100 to S230, which is the driving control process in the first example shown in FIG. 7, in the process after step S160. Accordingly, the following description will made mainly focusing on the process after step S160, and other descriptions will be omitted. Also, FIG. 9 shows a simplified version of steps S100 to S150. In addition, in the process after step S160, the same processes as in the first example will be indicated by the same step numbers.

After the process of step S150 shown in FIG. 9, the comparer 142 determines whether or not the degree of discrepancy is less than the threshold value for only one side in the results of comparing the dividing lines at the first distance D1 (step S160). If the degree of discrepancy for only one side is determined to be less than the threshold value, the driving controller 144 continues the driving control in the first driving mode (hands-off state) (step S170). Also, the comparer 142 compares the dividing lines at the second distance D2, which is shorter (closer to the vehicle M) than the first distance D1 (step S180), and determines whether or not the degree of discrepancy is less than the threshold value for the dividing lines on both sides (step S300). If it is determined that the degree of discrepancy is not less than the threshold value for the dividing lines on both sides, the comparer 142 determines whether or not the degree of discrepancy is less than the threshold value only on one side at the second distance D2 (step S310). If it is determined that the degree of discrepancy for only one side is not less than the threshold value, both sides do not match at the second distance D2, and thus the driving controller 144 switches from the first driving mode to the second driving mode and performs the driving control in the hands-on state (step S320).

Also, if it is determined in the process of step S310 that the degree of discrepancy is less than the threshold value only on one side at the second distance D2, the driving controller 144 determines whether or not the dividing lines on the one side on which the degree of discrepancy is less than the threshold value at the second distance D2 is on the same side as the dividing lines in which the degree of discrepancy is less than the threshold value at the first distance D1 (Step S330). In addition, if it is determined that they are not on the same side, the corrector 146 performs dividing line corrections on the basis of the position of each dividing line at the first distance D1 (step S340). Further, if it is determined in the process of step S330 that they are on the same side, or if it is determined in the process of step S300 that the degree of discrepancy is less than the threshold value for the dividing lines on both sides, the corrector 146 performs dividing line corrections on the basis of the position of each dividing line at the second distance D2 (step S350). Then, after the process of step S340 or step S350, the driving control in the first driving mode (hands-off state) is continued (step S360). Then, this flowchart ends.

Also, if it is determined in the process of step S160 that only one side does not match, the comparer 142 determines whether or not the degree of discrepancy is less than the threshold value for the dividing lines on both sides at the first distance D1 (step S370). If it is determined that the degree of discrepancy is less than the threshold value for the dividing lines on both sides, the process after step S340 is performed, and if it is determined that the degree of discrepancy is not less than the threshold value for the dividing lines on both sides, the process of step S320 is performed.

According to the third example, on the basis of the comparison results of the dividing lines at each of the first distance D1 and the second distance D2, the content of correction control can be varied depending on which side of the left and right dividing lines the degree of discrepancy is less than the threshold value. For that reason, more appropriate correction of the dividing lines can be performed, and more appropriate driving control can be realized using the corrected dividing lines.

According to the embodiment described above, the automated driving control device 100 (an example of the vehicle control device) includes: the first recognizer 132 that recognizes the left and right dividing lines seen from the vehicle M defining the driving lane of the vehicle M as the device dividing lines on the basis of the output of the detection device DD detecting the surrounding conditions of the vehicle M; the second recognizer 134 that recognizes the dividing lines defining the driving lane of the vehicle M from the map information as the map dividing lines on the basis of position information of the vehicle M; the comparer 142 that performs the left side dividing line comparison for comparing the device dividing line defining the left side of the driving lane with the map dividing line at the first distance in the traveling direction seen from the vehicle M, and the right side dividing line comparison for comparing the device dividing line defining the right side of the driving lane with the map dividing line, and if the results of the left side dividing line comparison and the right side dividing line comparison satisfy the specific condition, performs the left side dividing line comparison and the right side dividing line comparison at the second distance shorter than the first distance; and the driving controller (an example of the driving controller) that performs driving control of the vehicle on the basis of the comparison results of the comparer 142. The specific condition includes a condition in which the degree of discrepancy of only one of them in the results of the left side dividing line comparison and the right side dividing line comparison at the first distance is less than the threshold value, whereby more appropriate driving control can be performed on the basis of the recognition results of the road dividing lines. In addition, this can ultimately contribute to the development of sustainable transportation systems.

For example, according to the embodiment, in the comparison between the left and right device dividing lines and map dividing lines at a far distance (first distance) from the vehicle M (discrepancy determination), if the degree of discrepancy of only one of them is at least the threshold value, the comparison between the left and right device dividing lines and map dividing lines at a close distance (second distance) is performed, and the map dividing lines are corrected on the basis of the results, so that more appropriate recognition of the dividing lines or driving lanes is possible. Accordingly, the accuracy of estimating a host vehicle position can be improved. Also, according to the embodiment, if the first driving mode (hands-off state) is being executed, and in the comparison between the left and right device dividing lines and map dividing lines at a far distance (first distance), if the degree of discrepancy of only one of them is at least the threshold value, the first driving mode is continued, so that the continuity (stability) of the driving control can be improved.

The embodiment described above can be expressed as follows:

a vehicle control device including: a storage medium configured to store computer-readable instructions; and

a processor connected to the storage medium,

the processor executing the computer-readable instructions to:

recognize left and right dividing lines seen from a vehicle defining a driving lane of the vehicle as device dividing lines on the basis of an output of a detection device detecting surrounding conditions of the vehicle;

recognize dividing lines defining the driving lane of the vehicle from map information as map dividing lines on the basis of position information of the vehicle;

perform a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction seen from the vehicle, and if the results of the left side dividing line comparison and the right side dividing line comparison satisfy a specific condition, perform the left side dividing line comparison and the right side dividing line comparison at a second distance shorter than the first distance; and

perform control of the vehicle on the basis of the comparison results,

wherein the specific condition includes a condition in which a degree of discrepancy of only one of the results of the left side dividing line comparison and the right side dividing line comparison at the first distance is less than a threshold value.

Although the aspects for implementing the present invention have been described above using the embodiment, the present invention is not limited to such an embodiment, and various modifications and substitutions can be made without departing from the scope of the gist of the present invention. While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a memory storing a instructions; and
a processor configured to execute the instructions stored in the memory to:
recognize left and right dividing lines seen from a vehicle defining a driving lane of the vehicle as device dividing lines on the basis of an output of a detection device detecting surrounding conditions of the vehicle;
recognize dividing lines defining the driving lane of the vehicle from map information as map dividing lines on the basis of position information of the vehicle;
perform a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction seen from the vehicle, and if the results of the left side dividing line comparison and the right side dividing line comparison satisfy a specific condition, perform the left side dividing line comparison and the right side dividing line comparison at a second distance shorter than the first distance; and
perform control of the vehicle on the basis of the comparison results, wherein the specific condition includes a condition in which a degree of discrepancy of only one of the results of the left side dividing line comparison and the right side dividing line comparison at the first distance is less than a threshold value.

2. The vehicle control device according to claim 1,
wherein the control of the vehicle includes driving control in a first driving mode and a second driving mode in which a degree of driving assistance is lower or tasks on an occupant of the vehicle are greater than in the first driving mode, and
the processor continues the first driving mode if the first driving mode is being executed and the degree of discrepancy of only one of the results of the left side dividing line comparison and the right side dividing line comparison at the first distance is less than the threshold value.

3. The vehicle control device according to claim 2,
wherein the processor further executes instructions to:
correct the map dividing lines on the basis of the device dividing lines,
wherein the processor corrects the map dividing lines on the basis of the device dividing lines at the second distance if both degrees of discrepancy in the results of the left side dividing line comparison and the right side dividing line comparison at the second distance are less than the threshold value, and
the processor performs the control of the vehicle on the basis of the map dividing lines corrected.

4. The vehicle control device according to claim 3,
wherein if at least one of the degrees of discrepancy is at least the threshold value in the results of the left side dividing line comparison and the right side dividing line comparison at the second distance, the processor corrects the map dividing line on the basis of the device dividing line at the first distance for a dividing line of left and right dividing lines of the driving lane whose degree of discrepancy is less than the threshold value at the first distance, and the processor performs the control of the vehicle on the basis of the map dividing line corrected.

5. The vehicle control device according to claim 2, wherein the processor changes the control of the vehicle from the first driving mode to the second driving mode if the first driving mode is being executed and the degree of discrepancy of at least one of the results of the left side dividing line comparison and the right side dividing line comparison at the second distance is at least the threshold value.

6. The vehicle control device according to claim 2,
wherein the processor further executes instructions to:
correct the map dividing lines on the basis of the device dividing lines,
wherein if the degree of discrepancy of only one of the results of the left side dividing line comparison and the right side dividing line comparison at the second distance is less than the threshold value, the processor corrects the map dividing line on the basis of the device dividing line at the second distance for a dividing line of the left and right dividing lines whose degree of discrepancy at the first distance is less than the threshold value, and
the processor performs the control of the vehicle on the basis of the map dividing line corrected.

7. The vehicle control device according to claim 6, wherein if the dividing line of the left and right dividing lines whose degree of discrepancy at the second distance is less than the threshold value and the dividing line whose degree of discrepancy at the first distance is less than the threshold value are on the same side, the processor corrects the map dividing line on the basis of the device dividing line at the second distance for the dividing lines on the side on which the degrees of discrepancy of the left and right dividing lines are less than the threshold value.

8. The vehicle control device according to claim 1,
wherein the processor performs the control if a specific shape is present in the driving lane in the traveling direction of the vehicle, and
the specific shape includes at least one of a branching road, a merging road, an increase or decrease in the number of lanes, an increase or decrease in lane width, and an intersection.

9. The vehicle control device according to claim 8, wherein if the degree of discrepancy is at least the threshold value on the basis of the comparison results at the first distance for the dividing line of the left and right dividing lines on a side opposite to the side on which the specific shape is present, the processor performs the comparison at the second distance.

10. The vehicle control device according to claim 1, wherein the control of the vehicle includes at least one of steering control of the vehicle, speed control, and display control of the driving lane or the dividing line defining the driving lane.

11. A vehicle control method in which a computer executes:
recognizing left and right dividing lines seen from a vehicle defining a driving lane of the vehicle as device dividing lines on the basis of an output of a detection device detecting surrounding conditions of the vehicle;
recognizing dividing lines defining the driving lane of the vehicle from map information as map dividing lines on the basis of position information of the vehicle;
performing a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction seen from the vehicle, and if the results of the left side dividing line comparison and the right side dividing line comparison satisfy a specific condition, performing the left side dividing line comparison and the right side dividing line comparison at a second distance shorter than the first distance; and
performing control of the vehicle on the basis of the comparison results,
wherein the specific condition includes a condition in which a degree of discrepancy of only one of the results of the left side dividing line comparison and the right side dividing line comparison at the first distance is less than a threshold value.

12. A computer-readable non-transitory storage medium storing a program configured to cause a computer to execute:
recognizing left and right dividing lines seen from a vehicle defining a driving lane of the vehicle as device dividing lines on the basis of an output of a detection device detecting surrounding conditions of the vehicle;
recognizing dividing lines defining the driving lane of the vehicle from map information as map dividing lines on the basis of position information of the vehicle;
performing a left side dividing line comparison for comparing the device dividing line defining a left side of the driving lane with the map dividing line, and a right side dividing line comparison for comparing the device dividing line defining a right side of the driving lane with the map dividing line at a first distance in a traveling direction seen from the vehicle;
if the results of the left side dividing line comparison and the right side dividing line comparison satisfy a specific condition, performing the left side dividing line comparison and the right side dividing line comparison at a second distance shorter than the first distance; and
performing control of the vehicle on the basis of the comparison results,
wherein the specific condition includes a condition in which a degree of discrepancy of only one of the results of the left side dividing line comparison and the right side dividing line comparison at the first distance is less than a threshold value.
